(19) United States
(12) Patent Application Publication
(10) Pub. No.: US 2019/0296353 A1
(43) Pub. Date: Sep. 26, 2019

(54) Preparation method of graphene film anode material and application in aluminum ion battery

(71) Applicant: Hangzhou Gaoxi Technology Co., Ltd., Hangzhou, Zhejiang (CN)

(72) Inventors: Chao GAO, Hangzhou, Zhejiang (CN); Hao CHEN, Hangzhou, Zhejiang (CN)

(73) Assignee: Hangzhou Gaoxi Technology Co. Ltd., Hangzhou ,Zhejiang (CN)

(21) Appl. No.: 16/465,570

(22) PCT Filed: Feb. 27, 2018
(86) PCT No.: PCT/CN2018/077312

§ 371 Date: May 31, 2019

(30) Foreign Application Priority Data
Jun. 30, 2017 (CN) 201710522262.8

(51) Int. Cl. H01M 4/583; H01M 4/04; H01M 10/054; C01B 32/184

(52) U.S. Cl. CPC H01M 4/583; H01M 4/049; H01M 2004/027; H01M 10/054; C01B 32/184; H01M 4/0471

(57) ABSTRACT

The present invention discloses a method for preparing a graphene film anode material, which includes coating a graphene oxide solution on a substrate, drying, removing the substrate, performing reduction and obtaining a graphene film with ultra-high conductivity. The present invention also provides an application of the graphene film in an aluminum ion battery, which has relatively stable battery performance in a very wide temperature range of −40° C. to 120° C., maintains complete electrochemical performance after being bent for 10,000 times, and maintains 91% performance after 250,000 cycles. The present invention has advantages of simple operation and continuous controllable production method, is suitable for large-scale production, is low in cost, improves the energy density of the aluminum ion battery while ensuring high power density, and can be used for energy storage materials and device fields which need high safety, high power density, long life and wide temperature range and flexibility.

### CROSS REFERENCE OF RELATED APPLICATION

This is a U.S. National Stage under 35 U.S.C. 371 of the International Application PCT/CN2018/077312, filed Feb. 27, 2018, which claims priority under 35 U.S.C. 119(a-d) to CN 201710522262.8, filed Jun. 30, 2017.

### BACKGROUND OF THE PRESENT INVENTION

### Field of Invention

The present invention relates to a preparation method of a graphene film anode material with flexibility, ultra-high conductivity and wide temperature range, and an application thereof in an aluminum ion battery.

### Description of Related Arts

The aluminum ion battery is a new type of secondary battery that can be quickly charged and discharged. It has the advantages of low cost, high power density and high safety. It is regarded as a new energy storage technology that can replace supercapacitors. However, the current aluminum ion battery technology is mainly limited by its lower specific capacity of anode material, and the possibility and cost of large-scale processing. For example, the application for the Chinese invention patent No. CN104241596A (published on Dec. 24, 2014) discloses a kind of carbon paper aluminum ion battery anode which has a specific capacity of 90 mAh/g, and however, the flexibility, rate performance and cycle life of only several hundred cycles of the aluminum ion battery anode limit the application of the anode material.

At present, the cycle life and rate performance of the anode of aluminum ion battery are still important factors limiting the application of aluminum ion battery. Therefore, finding a suitable anode material to greatly improve the performance of the aluminum ion battery based on the graphene film is the top priority of the current research.

Generally, in the preparation of a graphene film, a hot pressing process and an additional applied pressure are often used to make the graphene film dense, which causes that the electrolyte is unable to be infiltrated into the graphene film, and thus cannot be used as an electrode material.

### SUMMARY OF THE PRESENT INVENTION

Aiming at deficiencies of the prior art, an object of the present invention is to overcome technical bias in the field and provide a preparation method of a graphene film anode material which is able to be infiltrated by an electrolyte, and an application of the graphene film anode material in an aluminum ion battery.

The object of the present invention is achieved through technical solutions as follows. A preparation method of a graphene film anode material comprises steps of:

(S1) coating a graphene oxide solution with a mass percentage in a range of 0.05%-5% on a substrate, drying, removing the substrate and obtaining a graphene oxide film; and

(S2) performing chemical reduction or high-temperature thermal reduction on the graphene oxide film, and obtaining the graphene film anode material with ultra high conductivity.

Preferably, in the step of (S1), a solvent of the graphene oxide solution is at least one member selected from a group consisting of deionized water. N,N-dimethylformamide, N-methyl-2-pyrrolidone, N,N-dimethylacetamide, ethanol, n-butanol and acetonitrile.

Preferably, in the step of (S1), the substrate is a polyethylene film, an aluminum foil, a copper foil, a polytetrafluoroethylene film, or a polyethylene terephthalate film; drying is under a vacuum pressure in a range of 0.1-100 KPa at 40-200° C.

Preferably, in the step of (S2), the chemical reduction is preformed through a chemical reducing agent which is hydrazine hydrate vapor, hydrogen iodide aqueous solution, or sodium ascorbate aqueous solution; the high-temperature thermal reduction is performed at 1000-3000° C.; the chemical reduction or the high-temperature thermal reduction is performed under nitrogen or argon atmosphere for 100-1000 min.

Preferably, in the step of (S2), a thickness of the obtained graphene film anode material with ultra high conductivity is in a range of 10 μm-1 mm.

An application of the graphene film anode material prepared by the above method in an aluminum ion battery comprises using graphene aerogel with ultra high conductivity as an anode of the aluminum ion battery, using a button battery case, a soft pack battery case or a stainless steel battery case as battery packaging, using aluminum or aluminum alloy as a cathode of the aluminum ion battery, and using glass fiber, polypropylene diaphragm, polytetrafluoroethylene diaphragm or polyethylene diaphragm as diaphragm.

Beneficially effects of the present invention are as follows. The present invention optimizes the preparation method of the graphene film anode material applied to the aluminum ion battery, so that the graphene film anode material has high orientation and permeability at the same time; compared with the aluminum ion battery which adopts existing graphene film anode materials, the aluminum ion battery which adopts the optimized graphene film anode material is significantly improved in power density and energy density, is still able to maintain 91% performance after 250,000 cycles, and has a very stable battery performance in a very wide temperature range from −40° C. to 120° C.

In addition, the graphene film with the fluffy structure still maintains a complete electrochemical performance after being bent for 10.000 times. Moreover, the graphene film is self-supporting, is able to be continuously produced, is low in cost, and has high practical application value in the future of electric vehicles and wearable devices.

### BRIEF DESCRIPTION OF THE DRAWINGS

FIG. 1 is a cycle performance curve of a graphene film-based aluminum ion battery prepared by the present invention under a constant current charge and discharge condition of 100 A/g.

FIG. 2 is a graph showing the capacity of the graphene film-based aluminum ion battery prepared by the present invention at 0-120° C. and the efficiency curve after optimization with charging voltage.

FIG. 3 is a graph showing the capacity and rate performance of the graphene film-based aluminum ion battery prepared by the present invention at −40° C. to 0° C.

FIG. 4 is a stable cycle curve of the graphene film-based aluminum ion battery prepared by the present invention at −30° C. to 80° C.

FIG. 5 is a comparison of an operating temperature range and a stability temperature range of the aluminum ion battery based on graphene film prepared by the present invention with commercial batteries and capacitors, wherein: A denotes lithium ion battery, B denotes water capacitor, C denotes organic capacitor, and D denotes aluminum ion battery of the present invention.

FIG. 6 is a flexible display of the aluminum ion battery based on graphene film prepared by the present invention, which can maintain 100% electrochemical performance at a bending angle in a range of 0-180° after being bent for 10,000 times, and can stably cycle more than 500 times under a condition of 180 degree bending.

FIG. 7 is an infiltration display photo of the graphene film anode material prepared by the present invention.

FIG. 8 is a photo of a self-supporting graphene film obtained by coating on a spherical substrate.

### DETAILED DESCRIPTION OF THE PREFERRED EMBODIMENT

For the graphene film of the present invention, the higher the degree of orientation and the stronger the electron transfer capability, the higher the conductivity of the graphene film. Therefore, those skilled in the art are dedicated to the preparation of a highly oriented graphene film and apply the highly oriented graphene film to a battery. The present invention overcomes the above technical prejudices, comprehensively considers the influence of orientation degree and permeability on the efficiency of the battery, optimizes the drying temperature, and obtains the graphene film anode material with flexibility, ultra-high conductivity and wide temperature use range through simple steps. The aluminum ion battery prepared by the graphene film has a significant increase in power density and energy density compared with the existing dense graphene film anode material, and still maintains 91% performance after 250,000 cycles. It has a very stable battery performance in a very wide temperature range of −40° C. to 120° C. In addition, the graphene film with the fluffy structure still maintains the complete electrochemical performance after being bent for 10,000 times.

The present invention is specifically described by following embodiments, which are only used to further illustrate the present invention, and are not to be construed as limiting the scope of the present invention. Some non-essential changes and adjustments made by those skilled in the art according to the content of the present invention are all within the protective scope of the present invention.

### First Embodiment

(S1) Dissolve 10 parts by weight of graphene oxide in 1000 parts by weight of deionized water, evenly stir for 4 h, and obtain an evenly dissolved and dispersed graphene oxide aqueous solution;

(S2) Evenly coat the graphene oxide aqueous solution on a PTFE (polytetrafluoroethylene) film, control a thickness of the coated graphene oxide aqueous solution is 500 μm, dry at a temperature of 60° C. and a pressure of 50 KPa, and obtain a graphene oxide film;

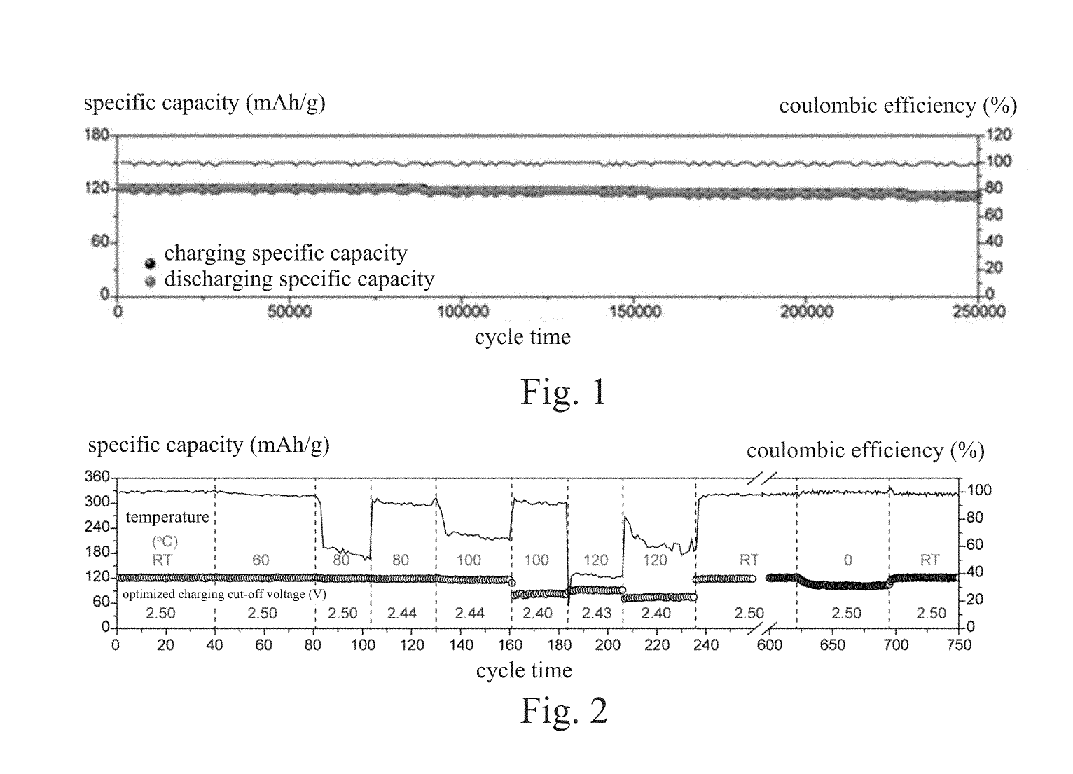

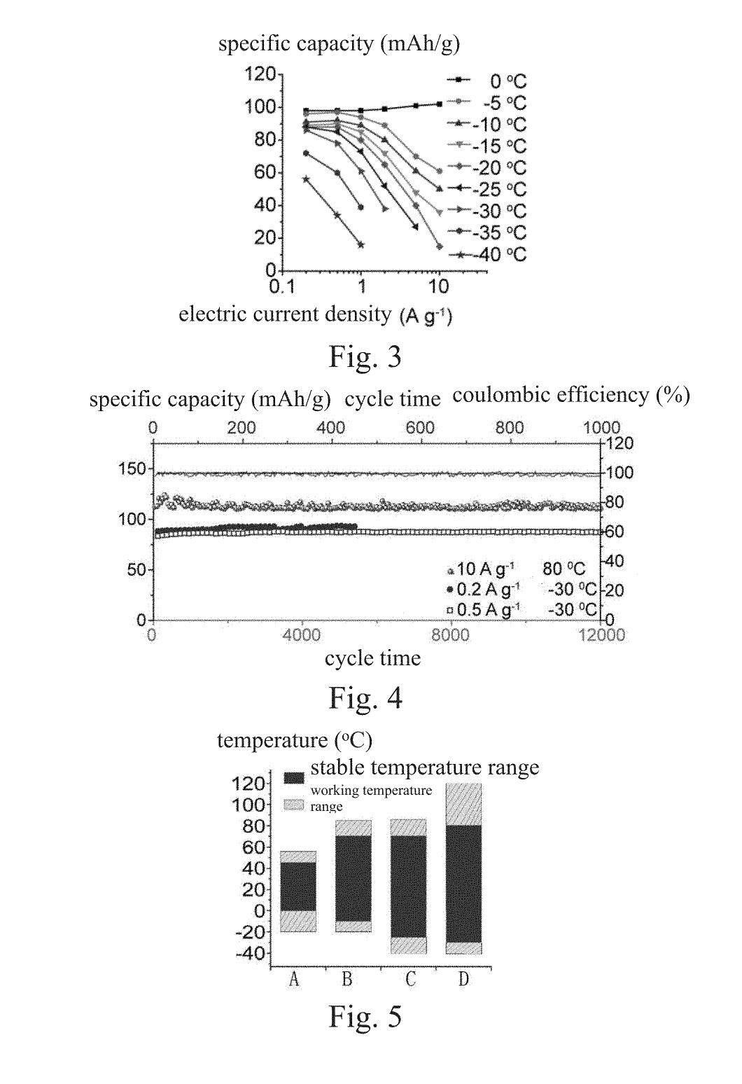

(S3) Heat the graphene oxide film under nitrogen atmosphere in a graphitization furnace to 2800° C., maintain at 2800° C. for 1 h, and obtain a graphene film with ultra high conductivity, wherein it is tested that a conductivity of the graphene film is larger than 10's/m and a density of the graphene film is higher than 1 mg/cm³; FIG. 3 shows a resistance change rate of a graphene film-based anode with compression; FIG. 2 shows a tensile curve of the graphene film-based anode provided by the present invention, it can be seen that the graphene film has a tensile strength of 20 MPa and a stretch ratio of 4%;

(S4) Cut the graphene film into a square anode sheet with a size of 50 cm×50 cm, assemble the anode sheet, an aluminum foil cathode sheet, a fiberglass diaphragm, an ionic liquid as electrolyte and an aluminum plastic film soft pack battery case, and obtain an aluminum ion battery which takes the graphene film as an anode, wherein FIG. 1 shows a cyclic performance curve of the aluminum ion battery based on the graphene film under a condition of 100 A/g constant current charge and discharge; it can be seen from FIG. 1 that the graphene film can provide a high specific capacity close to 120 mAh/g and can maintain 91% capacity after 250,000 cycles; and

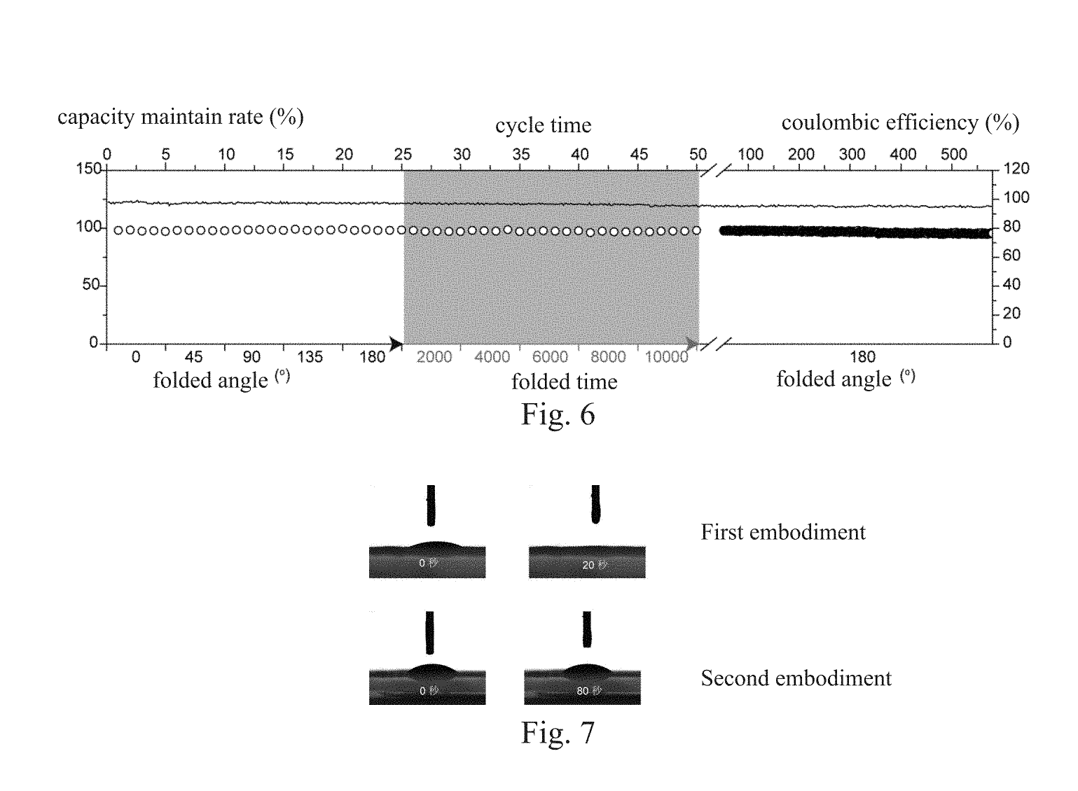

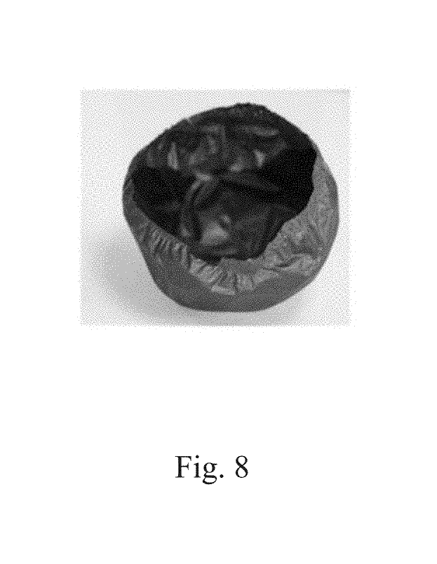

(S5) Place the prepared aluminum ion battery in a high and low temperature test cycle machine, and obtain an excellent temperature stability of the aluminum ion battery by performance tests at different temperatures, wherein as shown in FIG. 2, the graphene film anode still has a specific capacity of more than 115 mAh/g at 100° C., and maintains a stable cycle and coulombic efficiency under an effective charging cutoff voltage optimization method; as shown in FIG. 3, the graphene film anode still has a specific capacity of 117 mAh/g at 80° C., and can stably cycle for 12,000 times; the graphene film anode still has a specific capacity of 85 mAh/g at −30° C., and can stably cycle for 1,000 times; as shown in FIG. 4, the aluminum ion battery based on the graphene film still has better performance at −40° C., so performances of the aluminum ion battery based on the graphene film with an excellent wide temperature range are far more than those of conventional capacitors and lithium ion batteries, as shown in FIG. 5; through bending the obtained aluminum ion battery, it is tested that the performance of the battery is unchanged after being bent for 10,000 times, as shown in FIG. 6.

### Second Embodiment

(S1) Dissolve 0.5 parts by weight of graphene oxide in 1000 parts by weight of deionized water, evenly stir for 4 h, and obtain an evenly dissolved and dispersed graphene oxide aqueous solution;

(S2) Evenly coat the graphene oxide aqueous solution on a PTFE (poly tetra fluoroethylene) film, control a thickness of the coated graphene oxide aqueous solution is 500 μm, dry at a temperature of 60° C. and a pressure of 50 KPa, and obtain a graphene oxide film;

(S3) Perform reduction on the graphene oxide film through hydrazine hydrate vapor for 1 h, and obtain a graphene film with ultra high conductivity, wherein it is tested that a conductivity of the graphene film is larger than 10⁵ s/m, a density of the graphene film is higher than 1 mg/cm³, a tensile strength of the graphene film is 18 MPa and a stretch ratio of the graphene film is 3.7%;

(S4) Cut the graphene film into a square anode sheet with a size of 50 cm×50 cm, assemble the anode sheet, an aluminum foil cathode sheet, a fiberglass diaphragm, an ionic liquid as electrolyte and an aluminum plastic film soft pack battery case, and obtain an aluminum ion battery which takes the graphene film as an anode, wherein the graphene film can provide a high specific capacity close to 110 mAh/g and can maintain 92% capacity after 250,000 cycles; and

(S5) Place the prepared aluminum ion battery in a high and low temperature test cycle machine, and obtain an excellent temperature stability of the aluminum ion battery by performance tests at different temperatures, wherein the graphene film anode still has a specific capacity of more than 110 mAh/g at 100° C., and maintains a stable cycle and coulombic efficiency under an effective charging cutoff voltage optimization method; the graphene film anode still has a specific capacity of 114 mAh/g at 80° C., and can stably cycle for 12,000 times; the graphene film anode still has a specific capacity of 80 mAh/g at −30° C., and can stably cycle for 1,000 times; the aluminum ion battery based on the graphene film still has better performance at −40° C., so performances of the aluminum ion battery based on the graphene film with an excellent wide temperature range are far more than those of conventional capacitors and lithium ion batteries; through bending the obtained aluminum ion battery, it is known that the performance of the battery is unchanged after being bent for 10,000 times.

### Third Embodiment

(S1) Dissolve 50 parts by weight of graphene oxide in 1000 parts by weight of deionized water, evenly stir for 4 h, and obtain an evenly dissolved and dispersed graphene oxide aqueous solution;

(S2) Evenly coat the graphene oxide aqueous solution on a PTFE (poly tetra fluoroethylene) film, control a thickness of the coated graphene oxide aqueous solution is 500 μm, dry at a temperature of 60° C. and a pressure of 50 KPa, and obtain a graphene oxide film;

(S3) Heat the graphene oxide film under nitrogen atmosphere in a graphitization furnace to 1000° C., maintain at 1000° C. for 3 h, and obtain a graphene film with ultra high conductivity, wherein it is tested that a conductivity of the graphene film is larger than 10's/m, a density of the graphene film is higher than 1 mg/cm³, a tensile strength of the graphene film is 19 MPa and a stretch ratio of the graphene film is 3.9%;

(S4) Cut the graphene film into a square anode sheet with a size of 50 cm×50 cm, assemble the anode sheet, an aluminum foil cathode sheet, a fiberglass diaphragm, an ionic liquid as electrolyte and an aluminum plastic film soft pack battery case, and obtain an aluminum ion battery which takes the graphene film as an anode, wherein the graphene film can provide a high specific capacity close to 115 mAh/g and can maintain 91% capacity after 250,000 cycles; and

(S5) Place the prepared aluminum ion battery in a high and low temperature test cycle machine, and obtain an excellent temperature stability of the aluminum ion battery by performance tests at different temperatures, wherein the graphene film anode still has a specific capacity of more than 110 mAh/g at 100° C., and maintains a stable cycle and coulombic efficiency under an effective charging cutoff voltage optimization method; the graphene film anode still has a specific capacity of 110 mAh/g at 80° C., and can stably cycle for 12,000 times; the graphene film anode still has a specific capacity of 78 mAh/g at −30° C., and can stably cycle for 1,000 times; the aluminum ion battery based on the graphene film still has better performance at −40° C., so performances of the aluminum ion battery based on the graphene film with an excellent wide temperature range are far more than those of conventional capacitors and lithium ion batteries; through bending the obtained aluminum ion battery, it is known that the performance of the battery is unchanged after being bent for 10,000 times.

### First Comparative Example

(S1) Dissolve 50 parts by weight of graphene oxide in 1000 parts by weight of deionized water, evenly stir for 4 h, and obtain an evenly dissolved and dispersed graphene oxide aqueous solution;

(S2) Evenly coat the graphene oxide aqueous solution on a PTFE (poly tetra fluoroethylene) film, control a thickness of the coated graphene oxide aqueous solution is 500 μm, dry at a temperature of 60° C. and a pressure of 50 KPa, and obtain a graphene oxide film;

(S3) Perform reduction on the graphene oxide film through hydrazine hydrate vapor for 1 h, and obtain a graphene film with ultra high conductivity, wherein it is tested that a conductivity of the graphene film is larger than 10⁴ s/m, a density of the graphene film is higher than 1 mg/cm³, a tensile strength of the graphene film is only 6 MPa;

(S4) Cut the graphene film into a square anode sheet with a size of 50 cm×50 cm, assemble the anode sheet, an aluminum foil cathode sheet, a fiberglass diaphragm, an ionic liquid as electrolyte and an aluminum plastic film soft pack battery case, and obtain an aluminum ion battery which takes the graphene film as an anode, wherein the graphene film can provide a high specific capacity close to 60 mAh/g and can maintain 30% capacity after 10,000 cycles; and

(S5) Place the prepared aluminum ion battery in a high and low temperature test cycle machine, and obtain an excellent temperature stability of the aluminum ion battery by performance tests at different temperatures, wherein a specific capacity of the graphene film anode is decreased to 50 mAh/g at 100° C., a specific capacity of the graphene film anode is decreased to 55 mAh/g at 80° C., and a specific capacity of the graphene film anode is decreased to 30 mAh/g at −30° C.

### Second Comparative Example

(S1) Dissolve 10 parts by weight of graphene oxide in 1000 parts by weight of deionized water, evenly stir for 4 h, and obtain an evenly dissolved and dispersed graphene oxide aqueous solution;

(S2) Evenly coat the graphene oxide aqueous solution on a PTFE (poly tetra fluoroethylene) film, control a thickness of the coated graphene oxide aqueous solution is 500 μm, dry at a temperature of 60° C. and a pressure of 50 KPa, and obtain a graphene oxide film;

(S3) Heat the graphene oxide film under nitrogen atmosphere in a graphitization furnace to 2800° C., maintain at 2800° C. for 1 h, and obtain a graphene film with ultra high conductivity, wherein it is tested that a conductivity of the graphene film is larger than 10⁶ s/m, and a density of the graphene film is higher than 2 mg/cm³; and

(S4) Cut the graphene film into a square anode sheet with a size of 50 cm×50 cm, assemble the anode sheet, an aluminum foil cathode sheet, a fiberglass diaphragm, an ionic liquid as electrolyte and an aluminum plastic film soft pack battery case, and obtain an aluminum ion battery which takes the graphene film as an anode, wherein it has been tested that the aluminum ion battery has no performance, which is caused by the electrolyte being completely incapable of infiltrating into the dense electrode; as shown in FIG. 7, the droplet contact angle of the surface of the graphene film obtained by the second comparative example through hot pressing does not change within 80 seconds, which proves that there is no infiltration behavior; in contrast, the droplet contact angle of the surface of the graphene film obtained by the first comparative example through hot pressing became 0 after 20 seconds, demonstrating very good wettability.

What is claimed is:

1. A preparation method of a graphene film anode material comprising steps of:
(S1) coating a graphene oxide solution with a mass percentage in a range of 0.05%-5% on a substrate, drying under a vacuum pressure of 50 KPa at 60° C., removing the substrate and obtaining a graphene oxide film; and
(S2) performing chemical reduction or high-temperature thermal reduction on the graphene oxide film, and obtaining the graphene film anode material.

2. The preparation method, as recited in claim 1, wherein: in the step of (S1), a solvent of the graphene oxide solution is at least one member selected from a group consisting of deionized water, N,N-dimethylformamide, N-methyl-2-pyrrolidone, N,N-dimethylacetamide, ethanol, n-butanol and acetonitrile.

3. The preparation method, as recited in claim 1, wherein: in the step of (S1), the substrate is a polyethylene film, an aluminum foil, a copper foil, a polytetrafluoroethylene film, or a polyethylene terephthalate film.

4. The preparation method, as recited in claim 1, wherein: in the step of (S2), the chemical reduction is performed with a chemical reducing agent which is hydrazine hydrate vapor, hydrogen iodide aqueous solution, or sodium ascorbate aqueous solution; the high-temperature thermal reduction is performed at 1000-3000° C.; the chemical reduction or the high-temperature thermal reduction is performed under nitrogen or argon atmosphere for 100-1000 min.

5. The preparation method, as recited in claim 1, wherein: in the step of (S2), a thickness of the obtained graphene film anode material is in a range of 10 μm-1 mm.

6. A preparation method of an aluminum ion battery comprising applying the graphene film anode material as recited in claim 1 as an anode of the aluminum ion battery.

7. The preparation method of the aluminum ion battery, as recited in claim 6, further comprising steps of: using a button battery case, a soft pack battery case or a stainless steel battery case as battery packaging, using aluminum or aluminum alloy as a cathode of the aluminum ion battery, and using glass fiber, polypropylene diaphragm, polytetrafluoroethylene diaphragm or polyethylene diaphragm as diaphragm.
